(19) United States
(12) Patent Application Publication
(10) Pub. No.: US 2017/0317430 A1
(43) Pub. Date: Nov. 2, 2017

(54) WIRE WITH TERMINAL

(71) Applicant: SUMITOMO WIRING SYSTEMS, LTD., Mie (JP)

(72) Inventors: Masayuki KAWAMURA, Mie (JP); Naoyuki UEDA, Mie (JP)

(73) Assignee: SUMITOMO WIRING SYSTEMS, LTD., Mie (JP)

(21) Appl. No.: 15/490,108

(22) Filed: Apr. 18, 2017

(30) Foreign Application Priority Data
May 2, 2016 (JP) 2016-092300

(51) Int. Cl. H01R 4/18

(52) U.S. Cl. CPC H01R 4/185

(57) ABSTRACT

A terminal includes a sheath crimping portion having a bottom plate and a pair of sheath crimp tabs standing upright from two side portions of the bottom plate, the sheath crimping portion being crimped to an end portion of a sheath of a wire; and a core wire connection portion continuous with an end portion of the sheath crimping portion and connected to an exposed core wire of the wire. The sheath crimping portion includes a first crimped portion where a terminal edge portion on a side of the sheath crimping portion from which the sheath extends is crimped to the sheath, and a second crimped portion which is crimped to the sheath at a position closer to the exposed core wire than the first crimped portion. The second crimped portion is crimped to the sheath at a higher compression than the first crimped portion.

### CROSS-REFERENCE TO RELATED APPLICATIONS

The present application claims priority under 35 U.S.C. §119 of Japanese Application No. 2016-092300, filed on May 2, 2016, the disclosure of which is expressly incorporated by reference herein in its entirety.

### BACKGROUND OF THE INVENTION

### 1. Field of the Invention

The present invention relates to technology crimping a terminal onto an end portion of a wire.

### 2. Description of Related Art

Japanese Patent Laid-open Publication No. 2012-155892 discloses a configuration which includes a bottom plate, a pair of first upright portions, and a pair of second upright portions. In the bottom plate, a sheath crimping portion of a crimped terminal supports an insulating coating of a wire on one side. The pair of first upright portions are formed to stand upright from the bottom plate on two sides of the wire, and include a pair of swaging portions which occupy an area on a forefront end portion of the pair of first upright portions. The pair of first upright portions are overlaid on each other in a state where the swaging portions face the bottom plate, and are swaged to the insulating coating. The pair of second upright portions are formed at a position which leaves a space in a length direction of the wire between the first upright portions and the second upright portions, the pair of second upright portions standing upright from the bottom plate on two sides of the wire and formed to face each other. The pair of second upright portions include a pair of swaging portions which occupy an area on a forefront end portion of the pair of second upright portions. The pair of second upright portions are swaged to the insulating coating without being overlaid on each other, in a state where the swaging portions face the bottom plate.

Swaging the sheath crimping portion forcefully to the wire coating is believed to favorably increase retention power of the sheath crimping portion on the insulating coating of the wire.

However, when forcefully swaging the sheath crimping portion to the insulating coating, the inventors of the present invention have discovered that breakage of a core wire or the like due to trauma to the sheath or bending of the wire may occur at a rear terminal edge portion of the sheath crimping portion. In addition, in a case where a rubber stopper is engaged on an exterior of the insulating coating and the rubber stopper is interposed between the sheath crimping portion and the insulating coating, the inventors have discovered that cracks may develop in the rubber stopper.

Given this, the present invention is configured to be capable of improving retention power of a sheath crimping portion on a sheath of a wire, and of inhibiting breakage of a core wire, cracking of a rubber stopper, and the like due to trauma to the sheath and bending of the wire at a rear terminal edge portion of the sheath crimping portion.

### SUMMARY OF THE INVENTION

In order to resolve the above circumstances, a wire with terminal according to one aspect of the present invention includes a wire and a terminal. The wire includes a core wire and a sheath formed around a circumference of the core wire, and has an exposed core wire, where the core wire is exposed, formed at an extension direction portion of the wire. The terminal includes a sheath crimping portion having a bottom plate and a pair of sheath crimp tabs standing upright from two side portions of the bottom plate, the sheath crimping portion being crimped to an end portion of the sheath; and a core wire connection portion provided so as to be continuous with an end portion of the sheath crimping portion and connected to the exposed core wire. The sheath crimping portion includes a first crimped portion where a terminal edge portion on a side of the sheath crimping portion from which the sheath extends is crimped to the sheath, and a second crimped portion which is crimped to the sheath at a position closer to the exposed core wire than the first crimped portion. The second crimped portion is crimped to the sheath at a higher compression than is the first crimped portion.

According to another aspect of the present invention, the sheath crimping portion includes, as the pair of sheath crimp tabs, a pair of first sheath crimp tabs provided to the bottom plate at a side from which the sheath extends and a pair of second sheath crimp tabs provided closer to the exposed core wire than the pair of first sheath crimp tabs. A portion where the pair of first sheath crimp tabs are crimped to the sheath is the first crimped portion, and a portion where the pair of second sheath crimp tabs are crimped to the sheath is the second crimped portion.

According to another aspect of the present invention, a height dimension of the first crimped portion is defined to be greater than the height dimension of the second crimped portion.

With the wire with terminal according to the above-noted configuration, the second crimped portion is crimped to the sheath at a comparatively high compression, and therefore retention power of the sheath crimping portion with respect to the sheath of the wire can be kept somewhat higher. In addition, the first crimped portion, where the terminal edge portion of the sheath crimping portion on the side from which the sheath extends is crimped to the sheath, is crimped to the sheath at a comparatively low compression, and therefore the rear terminal edge portion of the sheath crimping portion is unlikely to dig into the sheath (or in a case where a rubber stopper is interposed, the rubber stopper), and breakage of the core wire, cracking of the rubber stopper, and the like due to trauma to the sheath and bending of the wire at the rear terminal edge portion of the sheath crimping portion can be inhibited.

According to the present invention, the pair of first sheath crimp tabs and the pair of second sheath crimp tabs can be swage deformed by separate crimping dies, and therefore the pair of first sheath crimp tabs and the pair of second sheath crimp tabs can be readily compressed at different compression rates.

According to the present invention, by adjusting a height during crimping, a difference can be imparted to the compression rates of the first crimped portion and the second crimped portion.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 is a side view illustrating a wire with terminal according to an embodiment of the invention;

FIG. 2 is a plan view illustrating the wire with terminal;

FIG. 3 is a cross-sectional view along a line III-III of FIG. 1;

FIG. 4 is a cross-sectional view along a line IV-IV of FIG. 1;

FIG. 5 is a perspective view illustrating a terminal prior to crimping;

FIG. 6 is an explanatory diagram illustrating one aspect of manufacturing the wire with terminal;

FIG. 7 is a side view illustrating a wire with terminal according to a modification;

FIG. 8 is a cross-sectional view illustrating a first crimped portion of a wire with terminal according to the modification; and

FIG. 9 is a cross-sectional view illustrating a second crimped portion of the wire with terminal according to the modification.

### DETAILED DESCRIPTION OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the forms of the present invention may be embodied in practice.

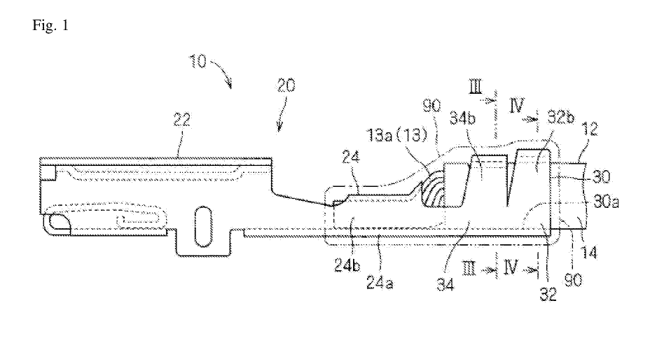

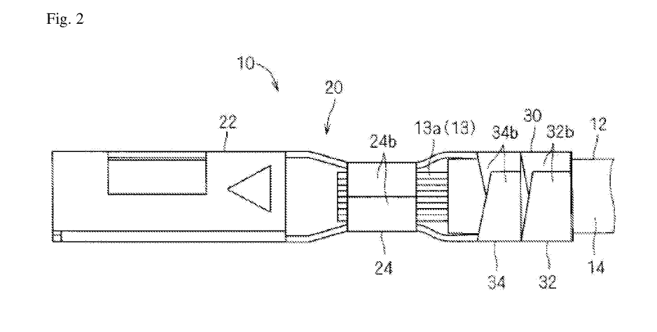

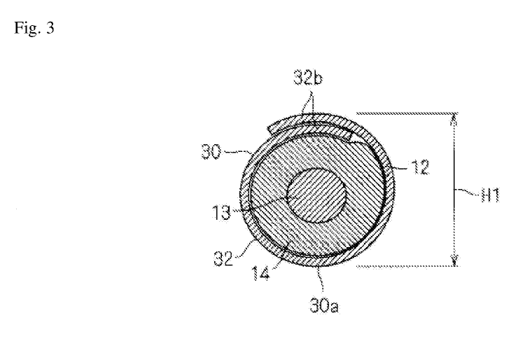

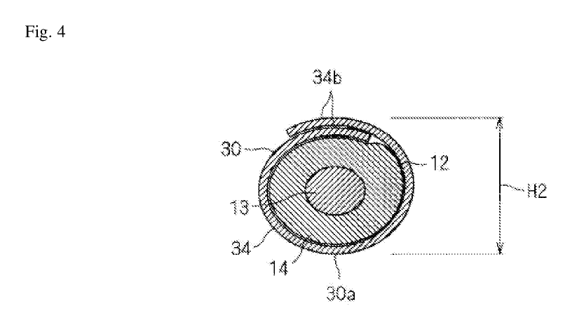

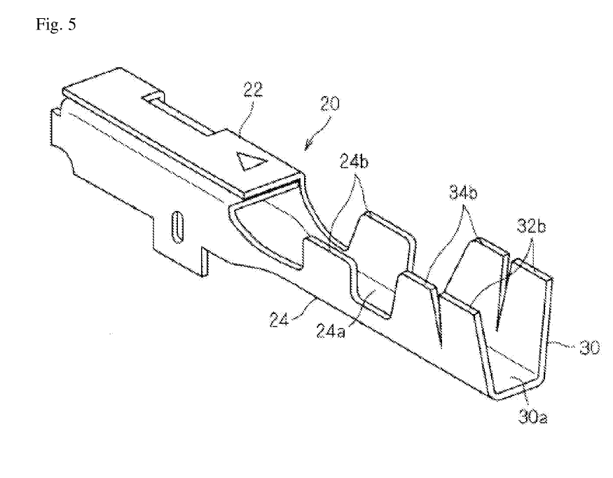

A wire with terminal according to an embodiment is described below. FIG. 1 is a side view illustrating a wire with terminal 10; FIG. 2 is a plan view illustrating the wire with terminal 10; FIG. 3 is a cross-sectional view along a line III-III of FIG. 1; FIG. 4 is a cross-sectional view along a line IV-IV of FIG. 1; and FIG. 5 is a perspective view illustrating a terminal 20 prior to crimping.

The wire with terminal 10 includes a wire 12 and the terminal 20.

The wire 12 is configured such that a sheath 14 coats an outer circumference of a core wire 13, the sheath 14 being applied by extrusion coating or the like. The core wire 13 is configured by a strand wire or solid wire of a metal such as copper, copper alloy, aluminum, or aluminum alloy, for example. Herein, an example is described in which the core wire 13 is configured by twisting together a plurality of metal wires of aluminum or an aluminum alloy. FIGS. 3 and 4 provide a simplified depiction of the core wire 13. Moreover, the sheath 14 on an end portion of the wire 12 is stripped, forming an exposed core wire 13a at a portion of the wire 12 in an extension direction (here, the end portion of the wire 12).

The terminal 20 is formed by, for example, appropriately press-working a metal plate of copper, copper alloy, or the like. A plating layer of tin or nickel, for example, may also be formed on a surface of the terminal 20. Here, an example is described where a tin plating layer is formed on the surface of the terminal 20.

The terminal 20 includes a mating connection portion 22, a core wire connection portion 24, and a sheath crimping portion 30.

The mating connection portion 22 is a portion connected to a mating terminal or the like and, in this example, is formed in a substantially tubular shape (referred to as a female terminal shape). In addition, a mating terminal having a pin- or tab-shaped connection portion (referred to as a male terminal) is inserted and connected to the mating connection portion 22. The mating connection portion 22 may instead be formed in a pin or tab shape (referred to as a male terminal shape), or may be formed in an annular shape capable of connecting to the mating member with threading, or the like.

The core wire connection portion 24 is configured to be capable of connecting with the exposed core wire 13a. In this example, the core wire connection portion 24 includes a bottom plate 24a and a pair of core wire crimp tabs 24b standing up in one direction from two side portions of the bottom plate 24a. In addition, in a state where the exposed core wire 13a is arranged on the bottom plate 24a, by bending the pair of core wire crimp tabs 24b inward so as to enfold the exposed core wire 13a, the core wire connection portion 24 is crimped to the exposed core wire 13a. Connecting a core wire connection portion and an exposed core wire is not limited to cases of crimping, and may instead be performed by welding methods such as ultrasonic welding or resistance welding, may be joined by soldering, or the like.

The sheath crimping portion 30 includes a bottom plate 30a and pairs of sheath crimp tabs 32b and 34b. In a state where an end portion of the sheath 14 is arranged on the bottom plate 30a, by bending the pairs of sheath crimp tabs 32b and 34b inward so as to enfold the sheath 14, the sheath crimping portion 30 is crimped to the end portion of the sheath 14. The bottom plate 24a is continuous with a first end portion of the bottom plate 30a, and the core wire connection portion 24 is provided so as to be continuous with a first end portion of the sheath crimping portion 30.

In a state where the sheath crimping portion 30 is crimped onto the sheath 14, the sheath crimping portion 30 includes a first crimped portion 32 and a second crimped portion 34. The first crimped portion 32 is a portion where a terminal edge of the sheath crimping portion 30 on a side from which the sheath 14 extends outward (a terminal edge on an opposite side from where the core wire connection portion 24 is provided) is crimped to the sheath 14. The second crimped portion 34 is a portion where a portion of the sheath crimping portion 30 closer to the exposed core wire 13a than the first crimped portion 32 is crimped to the sheath 14.

In this example, the sheath crimping portion 30 includes a pair of first sheath crimp tabs 32b and a pair of second sheath crimp tabs 34b as the pairs of sheath crimp tabs 32b and 34b.

The pair of first sheath crimp tabs 32b are provided to the bottom plate 30a on a side from which the sheath 14 extends (opposite side from the core wire connection portion 24). Then, by bending the pair of first sheath crimp tabs 32b inward so as to enfold the sheath 14, the pair of first sheath crimp tabs 32b are crimped to the sheath 14. A portion where the pair of first sheath crimp tabs 32b are crimped to the sheath 14 in this way is the first crimped portion 32.

Also, a length dimension, obtained by adding a width dimension of the bottom plate 30a to a length dimension of the pair of first sheath crimp tabs 32b, is greater than a circumferential length of the sheath 14. Therefore, in a state where the pair of first sheath crimp tabs 32b are swaged to the sheath 14, a leading edge portion of a first tab of the pair of first sheath crimp tabs 32b is overlaid on an exterior side of the leading edge portion of a second tab, and in this state the pair of first sheath crimp tabs 32b are crimped to the sheath 14. Accordingly, the leading edge portions of the pair of first sheath crimp tabs 32b are unlikely to dig into the sheath 14 and damage to the sheath 14 is inhibited. Furthermore, the pair of first sheath crimp tabs may instead be crimped to the sheath in a state where the leading edge portions of the pair of first sheath crimp tabs face each other.

The pair of second sheath crimp tabs 34b are provided to the bottom plate 30a on a side closer to the exposed core wire 13a than the pair of first sheath crimp tabs 32b. The first sheath crimp tabs 32b and the second sheath crimp tabs 34b are integral and continuous on the bottom plate 30a side. However, the first sheath crimp tabs 32b and the second sheath crimp tabs 34b are separated at the leading edge portions by a slit. Therefore, the pair of first sheath crimp tabs 32b and the pair of second sheath crimp tabs 34b do not influence each other and are independently swage-deformed. By bending the pair of second sheath crimp tabs 34b inward so as to enfold the sheath 14, the pair of second sheath crimp tabs 34b are crimped to the sheath 14. A portion where the pair of second sheath crimp tabs 34b are crimped to the sheath 14 in this way is the second crimped portion 34.

Also, a length dimension, obtained by adding the width dimension of the bottom plate 30a to a length dimension of the pair of second sheath crimp tabs 34b, is greater than the circumferential length of the sheath 14. Therefore, in a state where the pair of second sheath crimp tabs 34b are swaged to the sheath 14, a leading edge portion of a first tab of the pair of second sheath crimp tabs 34b is overlaid on an exterior side of the leading edge portion of a second tab, and in this state the pair of second sheath crimp tabs 34b are crimped to the sheath 14. Accordingly, the leading edge portions of the pair of second sheath crimp tabs 34b are unlikely to dig into the sheath 14 and damage to the sheath 14 is inhibited. Furthermore, the pair of second sheath crimp tabs may instead be crimped to the sheath in a state where the leading edge portions of the pair of second sheath crimp tabs face each other.

In FIGS. 1, 2, and 5, the slit formed between the first sheath crimp tabs 32b and the second sheath crimp tabs 34b is formed in a shape that narrows gradually toward a base end portion of the slit, but the slit may instead be a slit having a continuous, even width.

The second crimped portion 34 is crimped to the sheath 14 at a higher compression than the first crimped portion 32. In this example, a post-crimping cross-sectional area of the wire 12 in a crimping location is divided by a pre-crimping cross-sectional area to obtain a value referred to as a compression rate. The larger the value of the compression rate, the less the wire 12 is compressed, resulting in an evaluation as “low compression,” and the lower the value of the compression rate, the more the wire 12 is compressed, resulting in an evaluation as “high compression.”

In this example, the width dimensions of the first crimped portion 32 and the second crimped portion 34 are defined as approximately identical, and a height dimension H1 of the first crimped portion 32 is defined as larger than a height dimension H2 of the second crimped portion 34. The cross-sectional areas of the wire 12 in the first crimped portion 32 and the second crimped portion 34 are the same prior to crimping. In addition, an amount by which the height dimension H2 of the second crimped portion 34 is smaller than the height dimension H1 of the first crimped portion 32 is the amount by which the cross-sectional area of the wire 12 at the second crimped portion 34 is smaller than the cross-sectional area of the wire 12 at the first crimped portion 32. Therefore, the wire 12 has a highly compressed portion more greatly crimped at the second crimped portion 34 than at the first crimped portion 32. The first crimped portion 32 is crimped to the sheath 14 at a lower compression than the second crimped portion 34, but at a compression rate capable of holding the sheath 14 to a certain degree.

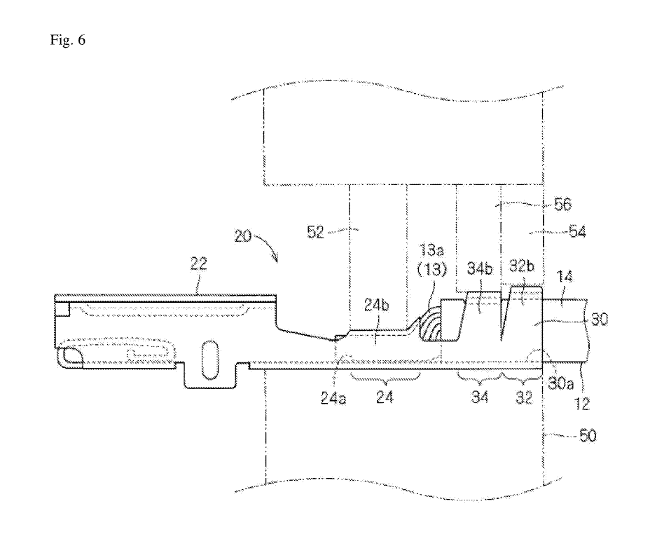

FIG. 6 is an explanatory diagram illustrating one aspect of manufacturing the wire with terminal 10.

When crimping the terminal 20 to the end portion of the wire 12, the terminal 20 is placed on an anvil 50, the end portion of the wire 12 is arranged on the terminal 20, and the pair of core wire crimp tabs 24b, the pair of first sheath crimp tabs 32b, and the pair of second sheath crimp tabs 34b are swage deformed by a core wire crimper 52, a first sheath crimper 54, and a second sheath crimper 56.

At this point, when the first sheath crimper 54 swage deforming the pair of first sheath crimp tabs 32b and the second sheath crimper 56 swage deforming the pair of second sheath crimp tabs 34b are provided as separate members, by adjusting height positions of the first sheath crimper 54 and the second sheath crimper 56 and changing the heights of the first crimped portion 32 and the second crimped portion 34, the second crimped portion 34 can be readily compressed at a higher compression than the first crimped portion 32. At this point, crimpers having an identical crimping surface shape can be used as the first sheath crimper 54 and the second sheath crimper 56.

In this example, the height dimensions of the pair of first sheath crimp tabs 32b and the pair of second sheath crimp tabs 34b are identical prior to crimping. However, the height dimensions of both pairs of sheath crimp tabs may also be modified such that the height dimension of the pair of first sheath crimp tabs 32b is larger than the height dimension of the pair of second sheath crimp tabs 34b, or the like.

With the wire with terminal 10 having the above-noted configuration, the second crimped portion 34 is crimped to the sheath 14 at a comparatively high compression, and therefore retention power of the sheath crimping portion 30 with respect to the sheath 14, and in particular retention power in a withdrawal direction, can be kept somewhat higher. In addition, the first crimped portion 32, which is situated at a terminal edge of the sheath crimping portion 30 on the side from which the sheath 14 extends, is crimped to the sheath 14 at a comparatively low compression. Therefore, a rear terminal edge of the bottom plate 30a of the sheath crimping portion 30 on the side from which the sheath 14 extends is unlikely to dig into the sheath 14. Therefore, trauma to the sheath 14 at the rear terminal edge of the sheath crimping portion 30, breakage of the core wire 13 due to bending of the wire 12, and the like can be inhibited. In a state where a rubber stopper is engaged on an exterior of the sheath 14, when the sheath crimping portion 30 is crimped to the rubber stopper, the rubber stopper is interposed between the sheath crimping portion 30 and the sheath 14, which can inhibit cracking of the rubber stopper.

In this regard, in a case where the core wire 13 and the terminal 20 are formed of different kinds of metal, such a case where the core wire 13 is formed of aluminum or an aluminum alloy and the terminal 20 is formed of copper or a copper alloy, galvanic corrosion between the core wire 13 and the terminal 20 needs to be inhibited, and therefore an anti-corrosion coating film 90 may be formed around the exposed core wire 13a and the core wire connection portion 24 (see the two-dot-dashed line in FIG. 1). In such a case, in the present embodiment, the sheath 14 is held by the second crimped portion 34, which is near the exposed core wire 13a, with a large retention force, and therefore even when the end portion of the sheath 14 or the like lengthens and contracts due to temperature changes, the end portion of the sheath 14 is unlikely to change position relative to the exposed core wire 13a. Therefore, cracks or the like are unlikely to form in the anti-corrosion coating film covering an outer circumference of the exposed core wire 13a and the core wire connection portion 24.

Also, the pair of first sheath crimp tabs 32b and the pair of second sheath crimp tabs 34b are provided as the pairs of sheath crimp tabs. Therefore, the pair of first sheath crimp tabs 32b and the pair of second sheath crimp tabs 34b can be respectively swage deformed by the first sheath crimper 54 and the second sheath crimper 56, which are independent crimping dies. Therefore, the pair of first sheath crimp tabs 32b and the pair of second sheath crimp tabs 34b can be readily adjusted and crimped at different compression rates.

In particular, by differing the height dimension H1 of the first crimped portion 32 and the height dimension H2 of the second crimped portion 34, the first crimped portion 32 and the second crimped portion 34 undergo different compression rates. Therefore, by adjusting the heights of the first sheath crimper 54 and the second sheath crimper 56, the crimping rates can be readily differentiated and adjustment of the compression rate is also facilitated.

### Modifications

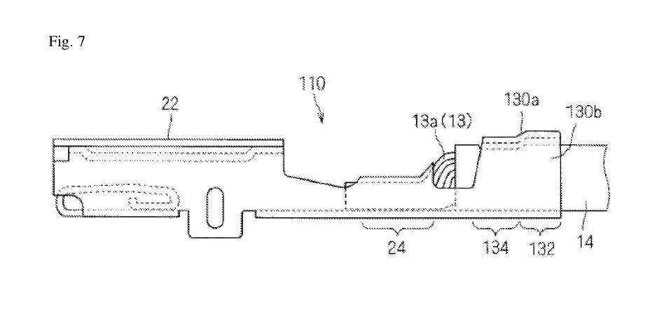

The above-described embodiment is configured to include the pair of first sheath crimp tabs 32b and the pair of second sheath crimp tabs 34b as the pairs of sheath crimp tabs. However, a wire with terminal 110 shown in FIG. 7 may instead be configured, for example, such that a tab on each side of a pair of sheath crimp tabs 130b is formed in an integral, continuous shape, and such that a portion of the pair of sheath crimp tabs 130b on the exposed core wire 13a side is recessed via a step 130s and is more greatly compressed relative to a side of the pair of sheath crimp tabs 130b from which the sheath 14 extends. In such a case, a portion of the pair of sheath crimp tabs 130b on the exposed core wire 13a side, which is more greatly crimped so as to be recessed, forms a second crimped portion 134 and a portion on the side from which the sheath 14 extends forms a first crimped portion 132.

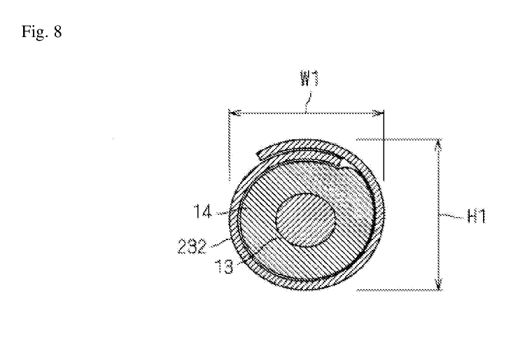

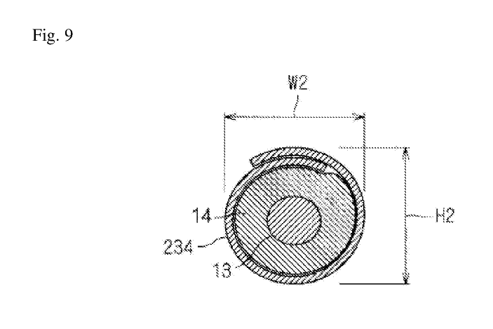

In addition, in the embodiment described above, by differing the height dimensions H1 and H2 of the first crimped portion 32 and the second crimped portion 34, respectively, the compression rates of the first crimped portion 32 and the second crimped portion 34 are differentiated. However, as shown in FIGS. 8 and 9, the height dimensions H1 and H2 as well as width dimensions W1 and W2 of a first crimped portion 232 and a second crimped portion 234, respectively, may both be differentiated and the compression rates of the first crimped portion 232 and the second crimped portion 234 may be differentiated. In such a case, a shape of a crimping surface of each crimper swage deforming the first crimped portion 232 and the second crimped portion 234, respectively, may be differentiated. Of course, a configuration is also possible in which only the width dimensions of the first crimped portion and the second crimped portion are differentiated to differentiate the compression rates of the first crimped portion and the second crimped portion.

In addition, in the embodiment described above, the sheath crimping portion 30 is configured with different compression rates at two stages. However, the compression rate may differ at a greater number of stages, or may change continuously.

Also, in the embodiment described above, an example is provided where the exposed core wire 13a is formed on the end portion of the wire 12. However, even in a case where an exposed core wire is formed at a middle portion of a wire and an intermediate splice terminal is crimped to the exposed core wire, a similar configuration can be applied to the portion crimped to the sheath 14.

Furthermore, the sheath crimping portion 30 may instead be crimped to a plurality of wire sheaths 14.

The configurations described in the above embodiment and modifications can be combined as appropriate so long as they do not contradict each other.

In the above, the present invention is described in detail. However, the above description is, in all aspects, for exemplary purposes and the present invention is not limited by the description. Numerous modifications not given as examples are understood to be conceivable without departing from the scope of the present invention.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible without departing from the scope of the present invention.

What is claimed is:

1. A wire with terminal comprising:
a wire having a core wire and a sheath formed around a circumference of the core wire, the wire having an exposed core wire extending from the sheath; and
a terminal comprising:
a sheath crimping portion having a bottom plate and a pair of sheath crimp tabs standing upright from two side portions of the bottom plate, the sheath crimping portion being crimped to an end portion of the sheath; and
a core wire connection portion continuous with an end portion of the sheath crimping portion and connected to the exposed core wire,
wherein the sheath crimping portion includes a first crimped portion at a terminal edge portion on a side of the sheath crimping portion from which the sheath extends, and a second crimped portion which is crimped to the sheath at a position closer to the exposed core wire than the first crimped portion, and the second crimped portion is crimped to the sheath at a higher compression than the first crimped portion.

2. The wire with terminal according to claim 1, wherein the pair of sheath crimp tabs include a pair of first sheath crimp tabs provided to the bottom plate at a side from which the sheath extends and a pair of second sheath crimp tabs provided closer to the exposed core wire than the pair of first sheath crimp tabs,
and a portion where the pair of first sheath crimp tabs are crimped to the sheath comprises the first crimped portion, and a portion where the pair of second sheath crimp tabs are crimped to the sheath comprises the second crimped portion.

3. The wire with terminal according to one of claims 1, wherein a height dimension of the first crimped portion is greater than the height dimension of the second crimped portion.

4. The wire with terminal according to one of claims 2, wherein a height dimension of the first crimped portion is greater than the height dimension of the second crimped portion.
